(19) United States
(12) Patent Application Publication
(10) Pub. No.: US 2022/0371935 A1
(43) Pub. Date: Nov. 24, 2022

(54) METHODS AND SYSTEMS FOR PRESS BENDING TWO OR MORE PLIES OF GLASS

(71) Applicant: Corning Incorporated, Corning, NY (US)

(72) Inventors: Stephane Poissy, Brunoy (FR); Billel Seneina, Le mée-sur-seine (FR); Larry Gene Smith, Tulsa, OK (US); John Christopher Thomas, Elmira, NY (US)

(21) Appl. No.: 17/770,869

(22) PCT Filed: Oct. 8, 2020
(86) PCT No.: PCT/US20/54700

§ 371 Date: Apr. 21, 2022

Related U.S. Application Data
(60) Provisional application No. 62/928,001, filed on Oct. 30, 2019.

(51) Int. Cl. C03B 23/03; C03B 23/035

(52) U.S. Cl. CPC C03B 23/0302; C03B 23/0305; C03B 23/0357; C03B 23/0355; C03B 23/0352; C03C 21/002

(57) ABSTRACT

Various embodiments disclosed include a method of bending a glass laminate structure, the method can optionally include any one or any combination of: heating the glass laminate structure comprising at least a first ply substrate and a second ply substrate, wherein the first ply substrate has a first composition and a first thickness that differ from a second composition and a second thickness of the second ply substrate; engaging an edge portion of one or both of a first major surface and a second major surface of the glass laminate structure; and sequent to engaging the edge portion, pressing the glass laminate structure to bend the glass laminate structure and obtain a desired curvature of the glass laminate structure along one or both of the first major surface and the second major surface.

### CROSS-REFERENCE TO RELATED APPLICATIONS

This application claims the benefit of priority under 35 U.S.C. § 119 of U.S. Provisional Application Ser. No. 62/928,001 filed on Oct. 30, 2019 the content of which is relied upon and incorporated herein by reference in its entirety.

### BACKGROUND

Glass parts used in a vehicle as a windshield, window, or the like often need to be curved to a specific degree before being included in the vehicle. Curving or bending the glass assembly can include exposing the glass part to an amount of heat that will cause the glass part to bend. If the heat applied to the glass part and other aspects of the forming are not properly controlled, defects may be imparted to the glass part or other deficiencies such as laminate separation can result. These defects and/or deficiencies can result in poor geometrical match to specification, poor optics quality and other undesirable properties.

### SUMMARY OF THE DISCLOSURE

The present disclosure provides a method for bending a glass substrate comprising at least a first ply substrate of a first composition and a second ply substrate of a second composition. The first ply substrate can have a thickness that differs from a thickness of the second ply substrate. The method can optionally comprise any one or any combination of: heating the glass laminate structure comprising at least the first ply substrate and the second ply substrate; engaging an edge portion of one or both of a first major surface and a second major surface of the glass laminate structure; and subsequent to engaging the edge portion, pressing the glass laminate structure to bend the glass laminate structure and obtain a desired curvature of the glass laminate structure along one or both of the first major surface and the second major surface.

The present disclosure provides a method of bending a glass substrate comprising only a first ply substrate of a first composition and a second ply substrate of a second composition. The first ply substrate can have a thickness that differs from a thickness of the second ply substrate. The method can optionally comprise any one or any combination of: heating the glass laminate structure; engaging a first major surface with a press mold to bend the glass laminate structure and obtain a desired curvature of the glass laminate structure along one or both of a first major surface and a second major surface; and pressure forming the glass laminate structure against the press mold with a compressed gas applied to the second major surface of the glass laminate structure.

The present disclosure further provides a system for bending a glass substrate. The system optionally includes any one or combination of a contour ring configured to extend along an x-direction and a y-direction of the glass laminate structure and configured to engage an edge portion of a first major surface of the glass laminate structure; a support ring extending along the x-direction and the y-direction of the glass laminate structure and comprising a support for the glass laminate structure along an edge portion of a second major surface of the glass laminate structure opposing the edge portion of the first major surface; and a press mold configured to engage a remainder of one of the first major surface or the second major surface outside the edge portion; wherein the contour ring is configured to be moveable relative to the press mold to selectively engage the edge portion of the first major surface of the glass laminate structure independent of the press mold.

The present disclosure further provides a glass laminate structure that is a windshield for a vehicle. The glass laminate structure can optionally comprise: a first curved glass substrate comprising a soda lime silicate glass, alkali aluminosilicate glass, alkali containing borosilicate glass, alkali aluminophosphosilicate glass, alkali aluminoborosilicate glass, or a mixture thereof, wherein the first glass substrate has a first thickness in a range from about 1.5 mm to about 10 mm; and a second curved glass substrate comprising one of a chemically strengthened glass or glass-ceramic material, and wherein the second glass substrate has a second thickness is in a range of from about 0.1 mm to about 1.7 mm.

### BRIEF DESCRIPTION OF THE FIGURES

The drawings illustrate generally, by way of example, but not by way of limitation, various embodiments discussed in the present document.

FIG. 1 is a perspective view of a vehicle having a windshield comprising a curved glass laminate structure according to an example of the present application.

FIG. 1A is an enlarged cross-sectional view of a portion of the glass laminate structure of FIG. 1 according to an example of the present application.

FIG. 2 is an exploded perspective view of a system for bending the glass laminate structure according to an example of the present application.

FIG. 3 is a cross-sectional view of the system of FIG. 2.

FIG. 3A is an enlarged cross-sectional view of a portion of the system of FIG. 3.

FIG. 4 is an exploded perspective view of a second system for bending the glass laminate structure according to another example of the present application.

FIGS. 5A-5H illustrate a method of bending a glass laminate structure such as the one of FIGS. 1 and 1A according to an example of the present application.

FIG. 6 illustrates a method of applying a compressed gas to the glass laminate structure of FIGS. 1 and 1A according to an example of the present application.

FIG. 7A shows a curvature of glass laminate structure as compared to a curvature of a press mold without the use of applying compressed gas to the glass laminate structure as illustrated in FIG. 6.

FIG. 7B shows a curvature of glass laminate structure as compared to a curvature of a press mold with the use of applying compressed gas to the glass laminate structure as illustrated in FIG. 6.

FIGS. 8A-8H illustrate a second method of bending a glass laminate structure such as the one of FIGS. 1 and 1A according to another example of the present application.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

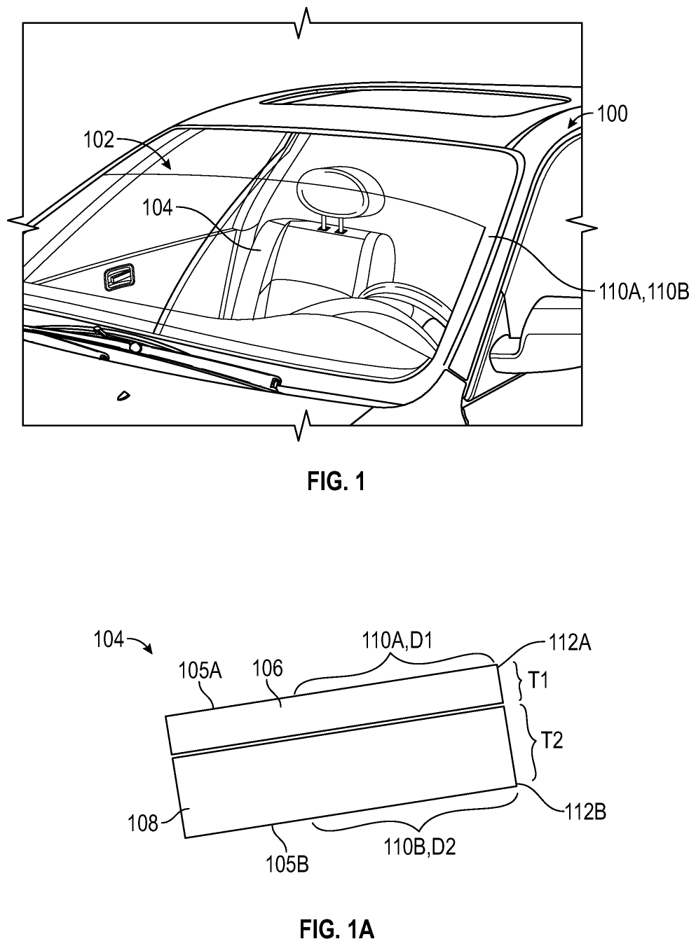

FIG. 1 is a perspective view of a vehicle 100 having a windshield 102 installed therein. The windshield 102 has a strength that meets specification and other requirements but also can have a lightweight design desirable for increasing fuel economy and performance of the vehicle 100. This lightweight design can be achieved using the systems and methods discussed herein. The systems and methods disclosed herein also can improve the quality of the formed glass (improvement to optical and spatial requirements), improve the performance and attributes of the formed glass, and provide for cost savings as the systems and methods allow for the formation of the glass with superior yield and throughput. To this end, the windshield 102 comprises a curved glass laminate structure 104 having a first major surface 105A and a second major surface 105B as illustrated in FIG. 1A. An enlarged portion of the glass laminate structure 104 is shown in FIG. 1A with the first major surface 105A and the second major surface 105B indicated. As shown in FIG. 1A, the glass laminate structure 104 can include a first ply substrate 106 and a second ply substrate 108. FIG. 1A shows the first major surface 105A can have an edge portion 110A (also illustrated in FIG. 1). The second major surface 105B can have an edge portion 110B (also illustrated in FIG. 1).

Although discussed in the context of a windshield, the methods and systems disclosed herein are also applicable to other components formed of glass structures such as displays, molding, trim, etc. Thus, the present disclosure should not be interpreted as limited to a windshield or even a vehicle. Similarly, the systems and methods of the present application should not be interpreted as limited to glass laminate structures only but can be used with other glass structures, glass laminate structures having further plies than the two illustrated and the like.

As shown in FIG. 1A, the edge portion 110A can comprise an area of first ply substrate 106 along the first major surface 105A that includes and terminates at a periphery 112A thereof. The edge portion 110A can also extend inward of the periphery 112A a distance D1 comprising about 0.1 mm to about 50 mm. Similarly, the edge portion 110B can comprise an area of the second ply substrate 108 along the second major surface 105B that includes and terminates at a periphery 112B thereof. The edge portion 110B can also extend inward of the periphery 112B a distance D2 comprising about 0.1 mm to about 50 mm. Alternatively, the edge portion 110A can be any area of the first major surface 105A engaged by the contour ring as described and illustrated subsequently. Similarly, the edge portion 110B can be any area of the second major surface 105B engaged by the support ring as described and illustrated subsequently.

The first ply substrate 106 can comprise an inner pane of the windshield 102 (FIG. 1) and the second ply substrate 108 can comprise an outer pane of the windshield 102. The first ply substrate 106 can have a first composition and a first thickness T1 that differ from a second composition and a second thickness T2 of the second ply substrate 108. Although the glass laminate structure 104 may only comprise the first ply substrate 106 and the second ply substrate 108 according to some examples, as is the case with the example of FIGS. 1 and 1A, it is contemplated that in some examples the glass laminate structure 104 can comprise more ply substrates that are not specifically shown, can have an interlayer between the first ply substrate 106 and the second ply substrate 108, or other configurations. If an interlayer is utilized, it can include any suitable material such as polyvinyl butyral, acoustic polyvinyl butyral, an ionomer, ethylene-vinyl acetate, a thermoplastic polyurethane, a polyester, polyethylene terephthalate, or a mixture thereof.

The first ply substrate 106 can have any suitable thickness T1 smaller than that of the second thickness T2 of the second ply substrate 108. For example, the first thickness T1 of the first ply substrate 106 can be in a range of from about 0.1 mm to about 1.7 mm, about 0.25 mm to about 1 mm, about 0.5 mm to about 0.75 mm, less than, equal to, or greater than about 0.1 mm, 0.2, 0.25, 0.3, 0.35, 0.4, 0.45 . . . etc., to about 1.7 mm.

The first ply substrate 106 can comprise a glass material or a glass-ceramic material such as Gorilla Glass® that has been formed to be a strengthened material (i.e., has been chemically strengthened (e.g., ion-exchanged treated) or thermally strengthened). As used herein, the term “strengthened material” generally refers to a glass material or a glass-ceramic material that has been chemically strengthened, for example through ion-exchange of larger ions for smaller ions in the surface of the glass or glass-ceramic material. However, other strengthening methods known in the art, such as thermal tempering, can be utilized to form strengthened glass materials and/or glass-ceramic materials. For example, an option contemplates the Gorilla Glass® can be non-ion exchanged.

The strengthened material described herein with regard to the first ply substrate 106 can be chemically strengthened by an ion-exchange process. The ion-exchange process can be performed by immersion of a glass or glass-ceramic material into a molten salt bath for a predetermined period of time. Ions at or near the surface(s) of the glass or glass-ceramic material are exchanged for larger metal ions from the salt bath. In one example, the temperature of the molten salt bath is in the range from about 400° C. to about 430° C. and the predetermined time period is about four to about twenty four hours; however the temperature and duration of immersion may vary according to the composition of the material and the desired strength attributes. The incorporation of the larger ions into the glass or glass-ceramic material strengthens the material by creating a compressive stress in a near surface region or in regions at and adjacent to the surface(s) of the material. A corresponding tensile stress is induced within a central region or regions at a distance from the surface(s) of the material to balance the compressive stress. Glass or glass-ceramic materials utilizing this strengthening process can be described more specifically as chemically-strengthened or ion-exchanged glass or glass-ceramic materials.

In one example, sodium ions in a glass or glass-ceramic material such as that of the first ply substrate 106 can replaced by potassium ions from the molten bath, such as a potassium nitrate salt bath, though other alkali metal ions having larger atomic radii, such as rubidium or cesium, can replace smaller alkali metal ions in the glass. According to embodiments of the present disclosure, smaller alkali metal ions in the glass or glass-ceramic can be replaced by Ag⁺ ions. Similarly, other alkali metal salts such as, but not limited to, sulfates, phosphates, halides, and the like can be used in the ion exchange process.

In contrast to the first ply substrate 106, the second ply substrate 108 may not be formed of a strengthened material. Thus, suitable material glass for the second ply substrate 108 can comprise soda lime silicate glass, alkali aluminosilicate glass, alkali containing borosilicate glass, alkali aluminophosphosilicate glass, alkali aluminoborosilicate glass, or a mixture thereof. In some embodiments, the soda lime silicate glass is substantially free of iron, iron oxide, or mixtures thereof.

The second ply substrate 108 can have any suitable thickness T2 larger than that of the first thickness T1 of the first ply substrate 106. For example, the second thickness T2 of the second ply substrate 108 can be in a range of from about 1 mm to about 10 mm, about 1.5 mm to about 5 mm, about 1.75 mm to about 2.5 mm, less than, equal to, or greater than about 1.75 mm, 2, 2.5, 3, 3.5, 4, 4.5, or about 5 mm.

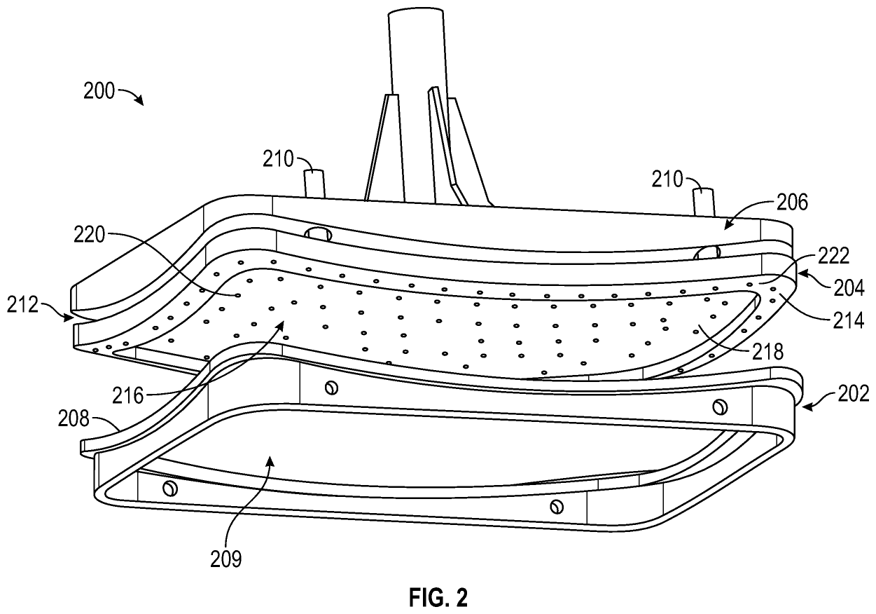

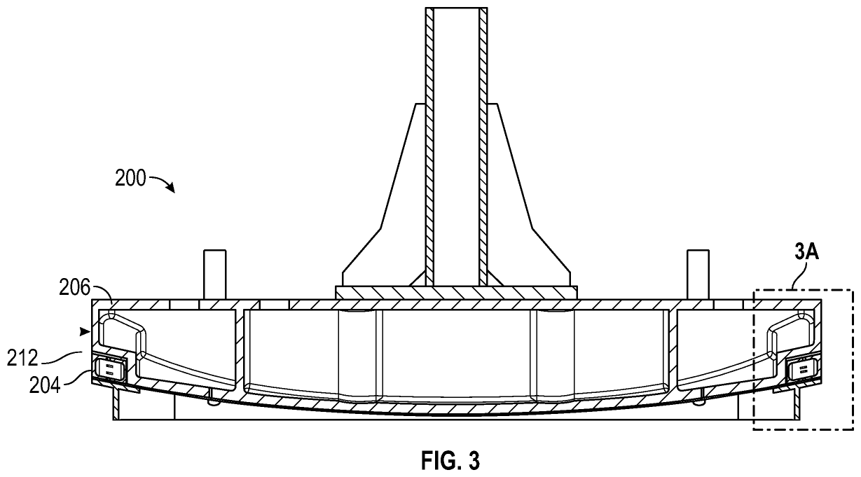

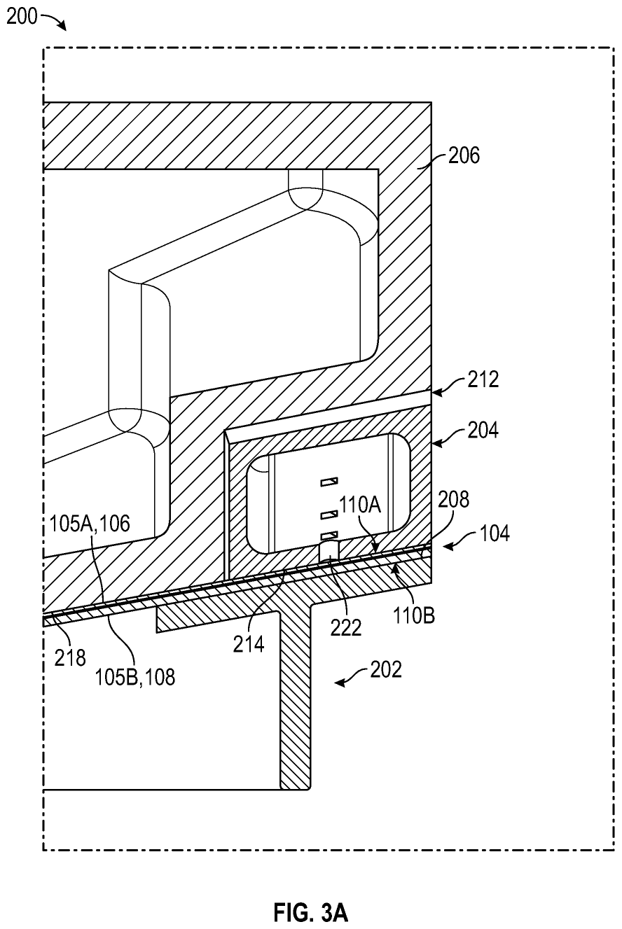

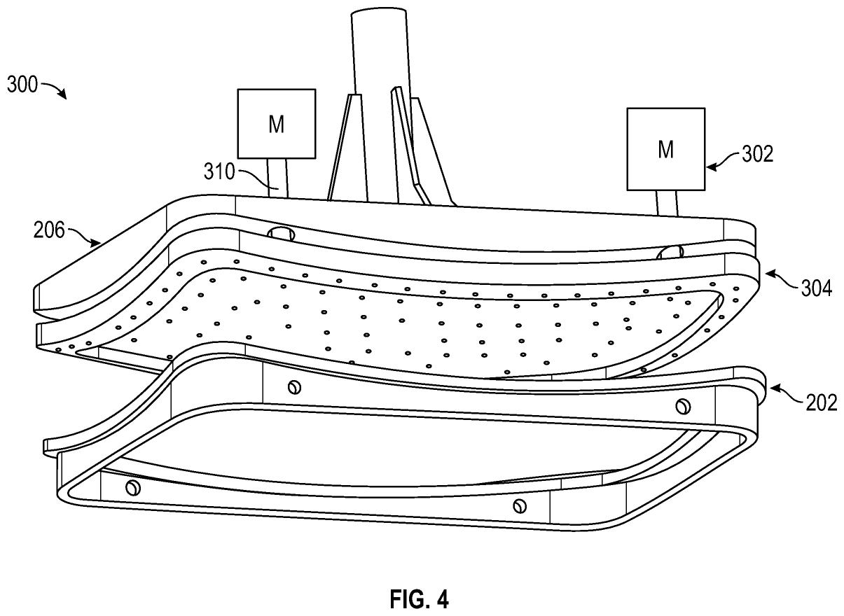

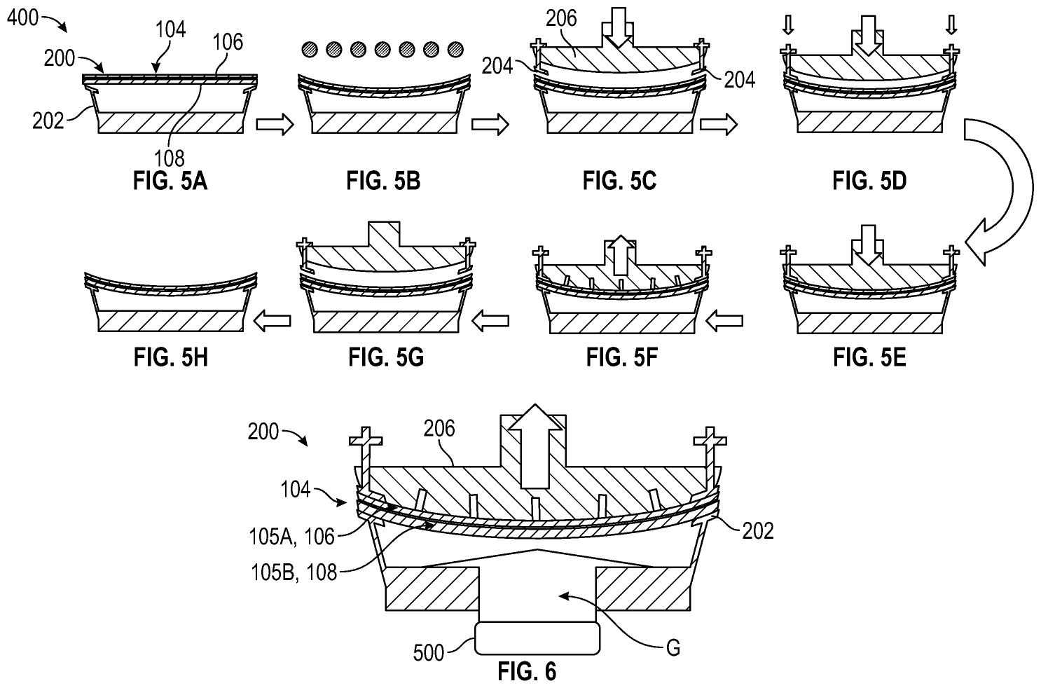

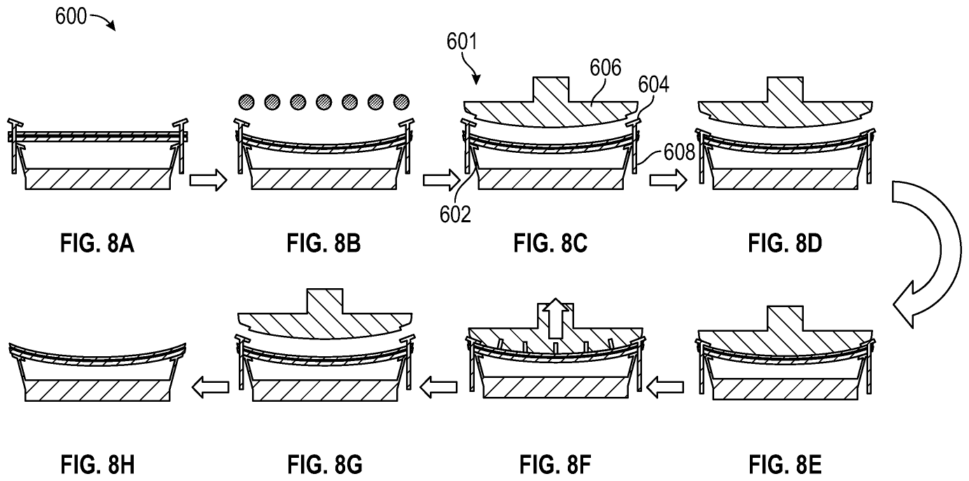

FIG. 2 is a perspective view of a system 200 for bending a glass structure that includes, but is certainly not limited to, the glass laminate structure 104 of FIGS. 1 and 1A. As shown in FIG. 2, the system 200 includes a support ring 202, a contour ring 204 and a press mold 206. Although three components are shown, in further embodiments system 200 can include fewer or more components. Other components and embodiments of the system are also contemplated as illustrated, for example, in FIG. 4 and FIGS. 8A-8H. The support ring 202 can comprise a support structure that extends generally in the x, y and z directions as shown in FIG. 2. The support ring 202 can be part of a mold structure as is further illustrated in FIGS. 5A-5H, for example. The support ring 202 can have a major surface 208 extending along the x, y, and z directions configured for supporting the glass structure in a desired manner during the processes discussed and further illustrated subsequently. In particular, as illustrated in FIG. 3A, the support ring 202 at the major surface 208 can be configured to engage and retain the glass laminate structure 104 at the edge portion 110B of second ply substrate 108 along the second major surface 105B.

The support ring 202 can comprise an open frame having an opening 209 in the middle configured to receive the glass structure when bent as further described and illustrated herein. The support ring 202 can be configured to be a stationary structure. Alternatively, the support ring 202 can be configured to be a mobile structure. For example, the support ring 202 can have wheels or skids attached to a bottom surface. This can be helpful in applications where the system 200 may be moved from one location to another, such as between zones in a furnace.

The contour ring 204 can be received in a recess 212 (best illustrated in FIGS. 3 and 3A) within the press mold 206. Thus, the recess 212 can be configured to receive the contour ring 204. The contour ring 204 can be configured to be moveable relative to the support ring 202 and the press mold 206. This can be in substantially only the z-direction illustrated in FIG. 2, for example. However, in other examples it is contemplated that the contour ring 204 can have further degrees of freedom to be moveable in the x and/or y directions as desired.

To the end of facilitating a guided movement of the contour ring 204, the contour ring 204 can have one or more guide rods 210 or other structures configured to guide movement of the contour ring 204 relative to the press mold 206 and/or the support ring 202. These guide rods 210 can be received in and can extend through the press mold 206. Guide rods 210 can comprise handles and other features that facilitate contour ring 204 to be manipulated (moved) independent of the press mold 206 to provide a different amount and/or desired amount of force via engagement at the edge portion 110A of the glass structure than the press mold 206. The contour ring 204 can have a major surface 214 configured to engage the glass structure with the desired amount of force during the one or more of the processes discussed and further illustrated subsequently. The major surface 214 can extend along the x, y, and z directions and can be configured to provide a desired geometry such as a curvature to the edge portion 110A (FIG. 3A). As illustrated in FIG. 3A, the contour ring 204 at the major surface 214 can be configured to engage and retain the glass laminate structure 104 at the edge portion 110A of first ply substrate 106 along the first major surface 105A. The major surface 214 can be configured to correspond generally to the shape of the major surface 208 of the support ring 202 such that the major surface 214 and the major surface 208 can be configured to be arranged substantially parallel to one another. Put another way, the major surface 214 and the major surface 208 can be configured to interface with one another with the glass structure interposed therebetween as shown in FIG. 3A.

Returning to FIG. 2, the contour ring 204 can have a major dimension, measured in either the x-direction or the y-direction. Like the support ring 202, the contour ring 204 can comprise an open frame structure having an extent in the x, y and z directions and can define a recess 216 in a middle thereof configured to receive portions of the press mold 206 and the glass structure during portions of the processing described and illustrated subsequently.

As shown in FIG. 2, the press mold 206 can be shaped to impart a desired curvature to the glass structure via engaging the heated glass structure in concert with the contour ring 204 and the support ring 202. To this end, the press mold 206 can have a major surface 218 configured to impart a desired shape to a middle portion of the glass structure. The major surface 218 can be rectangular (or another shape) in the x-y dimensions but can have a curvature in one or both of the x-z dimension and/or the y-z dimension. However, in other examples the major surface 218 may be substantially linear instead of having a curvature. The press mold 206, and in particular the major surface 218, can be configured to work in concert with the major surface 214 of the contour ring 204 to impart the desired shape (here an amount of curvature) along substantially an entirety of the glass laminate structure 104. Thus together, the profile of the press mold 206 and the contour ring 204 can be substantially commensurate with the profile of first major surface 105A (FIG. 1A) of the glass laminate structure 104.

The press mold 206 can be powered by a hydraulic mechanism, by gravity, electronically, or manually. In some embodiments, the press mold 206 can include heating or cooling mechanisms that can, in turn, heat or cool a glass substrate to which it is positioned proximately or in contact with. In further embodiments, heating or cooling mechanisms can be used to maintain the thermal conditions in the glass substrate (e.g., to maintain a desired temperature).

As shown in FIG. 2, the press mold 206 can have a plurality of vacuum ports 220 therein. Similarly, the contour ring 204 can have a plurality of vacuum ports 222 therein. These vacuum ports 220, 222 can be utilized to produce a vacuum or pressure differential at the first major surface 105A of the glass laminate structure 104.

The size of the vacuum ports 220, 222 can individually be in a range of from about 0.2 mm to about 10 mm, about 2 mm to about 6 mm, less than, equal to, or greater than about 2 mm, 2.5, 3, 3.5, 4, 4.5, 5, 5.5, 6, 6.5, 7, 7.5, 8, 8.5, 9, 9.5, or about 10 mm in diameter. Moreover, the vacuum ports 220, 222 can individually account for about 1 vol % to about 8 vol % of the press mold 206 and/or the contour ring 204, about 2 vol % to about 7 vol %, about 4 vol % to about 6 vol %, less than, equal to, or greater than about 1 vol %, 1.5, 2, 2.5, 3, 3.5, 4, 4.5, 5, 5.5, 6, 6.5, 7, 7.5, or about 8 vol %. A cross sectional geometry of the vacuum ports 220, 222 can substantially conform to a circular shape or polygonal shape. Examples of suitable circular shapes can include an elongated or non-elongated circle. Examples of suitable polygonal shapes include a triangular shape, a quadrilateral shape, a pentagonal shape, a hexagonal shape, or any higher order polygonal shape.

FIG. 3 shows a cross-section of the system 200 of FIG. 2 together as an assembly applying a curvature to a glass structure that can comprise the glass laminate structure previously illustrated in FIGS. 1 and 1A. FIG. 3A shows an enlarged cross-sectional view of the contour ring 204 and support ring 202 of FIGS. 2 and 3 and further shows the glass laminate structure 104.

As shown in FIGS. 3 and 3A, the recess 212 of the press mold 206 receives the contour ring 204 therein. This arrangement can substantially align the major surface 218 of the press mold 206 with the major surface 214 of the contour ring 204. This substantial alignment of the major surface 218 and the major surface 214 can impart the desired shape (here substantially aligned shape with a substantially uniform degree of curvature between areas that interface with the major surface 214 and areas that interface with the major surface 218) to the glass structure as result of the processing discussed subsequently.

Referring now to FIG. 3A, the contour ring 204 at the major surface 214 can be configured to engage and retain the glass laminate structure 104 at the edge portion 110A of first ply substrate 106 along the first major surface 105A. The major surface 214 can be configured to correspond generally to the shape of the major surface 208 of the support ring 202 such that the major surface 214 and the major surface 208 can be configured to be arranged substantially parallel to one another. The support ring 202 at the major surface 208 can be configured to engage and retain the glass laminate structure 104 at the edge portion 110B of second ply substrate 108 along the second major surface 105B.

FIG. 3A shows the contour ring 204 can be shaped as a hollow frame having an internal cavity. This shape can allow for application of the vacuum or pressure differential to the plurality of vacuum ports 222. This shape can also configure the contour ring 204 to engage the glass laminate structure 104 with a desired force at the edge portion 110A.

FIG. 4 shows an alternative example of a system 300 that includes the support ring 202 and the press mold 206 as previously described and a contour ring 304 that differs from the contour ring 204 of FIGS. 2-3A. More particularly, the contour ring 304 can include a mass 302 coupled thereto such as at one or more of the plurality of guide rods 310. Although illustrated as part of the guide rods 310, the mass 302 can form another part of the contour ring 304. For example, the contour ring 304 can be made solid or more solid (not having a hollow frame or having a smaller internal cavity) than was previously illustrated so as to provide increased mass. The addition of the mass 302 can configure the contour ring 304 to engage the glass laminate structure with a desired force at the edge portion. It is contemplated that various configurations and designs for the contour ring can be swapped out with the same press mold to achieve desired specifications depending upon the type/configuration of glass structure utilized.

FIGS. 5A-5H show an exemplary method 400 of bending and otherwise processing to achieve the glass laminate structure 104 of FIG. 1. FIGS. 5A-5H show the system 200 previously described but in a highly schematic manner.

FIG. 5A shows the first ply substrate 106 and the second ply substrate 108 of the glass laminate structure 104 loaded onto the support ring 202. In FIG. 5B, the glass laminate structure 104 can be heated for a duration of time to achieve a pre-sag and bend of a central portion of the glass laminate structure 104. Once the glass laminate structure 104 is bent to a suitable degree, the support ring 202 and glass laminate structure 104 can be moved or the press mold 206 and the contour ring 204 can be moved into position as illustrated in FIG. 5C.

As an example, the glass laminate structure 104 can be heated to a temperature in a range of from about 600° C. to about 800° C., about 700° C. to about 750° C., less than, equal to, or greater than about 600, 605, 610, 615, 620, 625, 630, 635, 640, 645, 650, 655, 660, 665, 670, 675, 680, 685, 690, 695, 700, 705, 710, 715, 720, 725, 730, 735, 740, 745, 750, 755, 760, 765, 770, 775, 780, 785, 790, 795, or about 800° C.

FIG. 5D shows the contour ring 204 (prior to pressing with the press mold) can be moved (as indicated with arrows) relative to the support ring 202 and the press mold 206 to engage the edge portion 110A (FIG. 3A) of first ply substrate 106 along the first major surface 105A (FIG. 3A) with a desired force (e.g. the desired force can be sufficient to exert a pressure of between about 1 and about 50 mBar on the edge portion 110A). As illustrated in FIG. 5D, the support ring 202 can be configured to engage the edge portion 110B (FIG. 3A) of the second ply substrate 108 along the second major surface 105B (FIG. 3A) with an opposing force to the desired force. The desired force can be sufficient to form a seal at the edge portion 110A and 110B to seal a region between the first ply substrate 106 and the second ply substrate 108. Engagement by the contour ring 204 with the desired force (e.g., a force less than the force applied by the press mold 206) can reduce instances of rippling at the edge portion 110A and 110B previously experienced with systems that only used a press mold for forming. As used herein, the term “rippling” refers to wrinkles or distortions that can be visually detected by the naked eye according to ASTM C1652/C1652M.

FIG. 5E shows pressing by both the contour ring 204 and the press mold 206 on the glass laminate structure 104 to achieve a desired curvature. The pressing as shown in FIGS. 5D and 5E can be actuated manually or through engagement with any other device configured to interact with the glass laminate structure 104. In some embodiments, actuation of the contour ring 204 and/or press mold 206 can be driven by a controller programed to drive actuation according to a predetermined schedule and according to a predetermined rate, for example.

Optionally, as shown FIG. 5F, vacuum forming can be performed during the pressing. In particular, the first ply substrate 106 along one or more areas of the first major surface 105A can be vacuumed against the press mold 206 and/or the contour ring 204. FIG. 5G shows the vacuum forming and bending stopped and the contour ring 204 and the press mold 206 removed from engagement with the glass laminate structure 104. Optionally, the glass laminate structure 104 can be annealed as shown in FIG. 5H for a period of time.

FIG. 6 illustrates that alternatively, or in addition to the method illustrated in FIGS. 5A-5H, pressure forming of the glass laminate structure 104 can be performed. This pressure forming can force the glass laminate structure 104, and in particular, the first ply substrate 106, against the press mold 206 with a compressed gas G applied to the second major surface 105B of the second ply substrate 108. To this end the system 200 can be provided with a gas supply conduit 500 configured to provide the compressed gas to the second major surface 105B inward of the support ring 202. It should be noted that pressure forming of FIG. 6 can be performed during the vacuum forming of FIG. 5F, for example. Alternatively, pressure forming can be performed at other steps in the method 400 such as the pressing step of FIG. 5E, for example. Thus, the pressure forming need not be limited to being with the vacuum forming step. Furthermore, although illustrated in concert with the contour ring 204 in FIG. 6, the pressure forming of FIG. 6 need not be utilized with a system including a contour ring as described herein but can be utilized simply with a system that only has a press mold and support ring, for example.

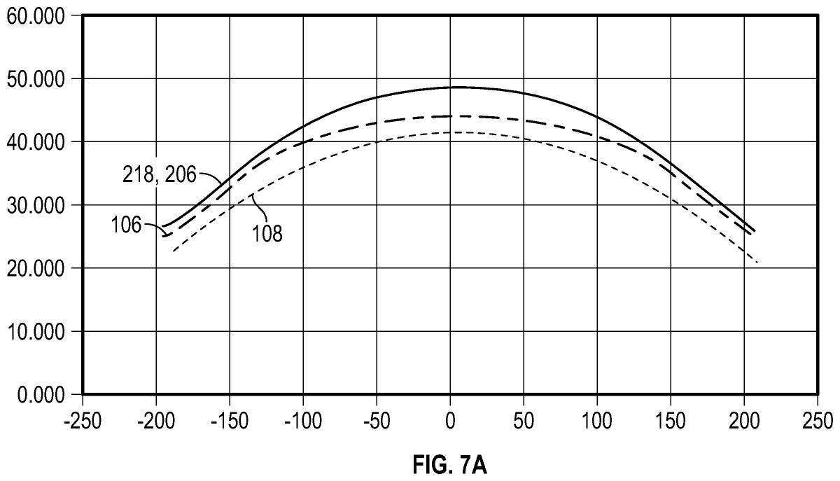

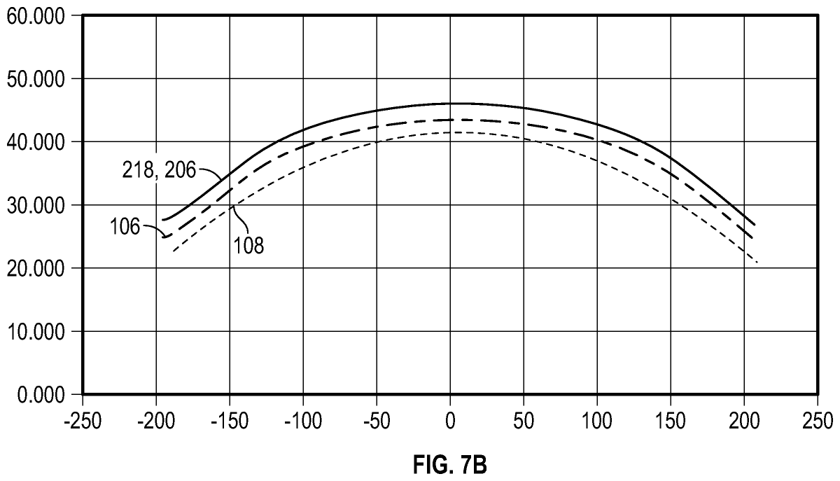

FIG. 7A shows a curvature of the first ply substrate 106 and the second ply substrate 108 as measured against a curvature of the surface 218 of the contour ring 206 without the use of pressure forming of FIG. 6. FIG. 7B shows a curvature of the first ply substrate 106 and the second ply substrate 108 as measured against the curvature of the contour ring 206 with the use of pressure forming of FIG. 6. As shown, the curvature of the first ply substrate 106 and the second ply substrate 108 of FIG. 7B exhibit a better conformity to the curvature of the surface 218 of the contour ring 206 such that tighter tolerances and conformity to specification can be achieved using pressure forming.

FIGS. 8A-8H show a method 600 similar to method 400 illustrated in FIGS. 5A-5H with the exception that the method 600 utilizes an alternative system 601 configuration. In particular, the system 601 includes a contour ring 604 that can be coupled to a support ring 602 instead of being coupled to the press mold 606 as is the case with system 200. Put another way, the contour ring 604 can be entirely independent of the press mold 606 and can be received in, or otherwise coupled to, the support ring 602. In the configuration of FIGS. 8A-8H the contour ring 604 can have one or more guide rods 608 that are received in or extend past the support ring 602, for example. Thus, the guide rods 608 are configured in an opposite manner as those in the system 200. Alternatively, the contour ring can be independent (i.e. may not be coupled to either the support ring 602 or the press mold 606) in some embodiments but can rather be a separate system component disposed to a side of the support ring 602 and press mold 606 and selectively inserted therebetween, for example.

As a result of the methods and systems described herein, by which the glass laminate structure 104 can be formed, the glass laminate structure 104 can be formed to more precise specifications and can avoid distortions or defects such as the rippling effect as discussed herein.

As discussed previously, the glass laminate structure 104, or indeed another glass structure not specifically illustrated herein, can utilize the systems and methods disclosed herein and can be included in a vehicle such as an automobile, watercraft, or aerospace vehicle. However, as noted previously, the system and methods are not only limited to glass structures for vehicles but can be utilized in other components.

### Additional Embodiments

The following exemplary embodiments are provided, the numbering of which is not to be construed as designating levels of importance:

Embodiment 1 provides a method of bending a glass laminate structure, the method can optionally comprise any one or any combination of: heating the glass laminate structure comprising at least a first ply substrate and a second ply substrate, wherein the first ply substrate has a first composition and a first thickness that differ from a second composition and a second thickness of the second ply substrate; engaging an edge portion of one or both of a first major surface and a second major surface of the glass laminate structure; and subsequent to engaging the edge portion, pressing the glass laminate structure to bend the glass laminate structure and obtain a desired curvature of the glass laminate structure along one or both of the first major surface and the second major surface.

Embodiment 2 provides the method of Embodiment 1, optionally wherein engaging the edge portion comprises moving a contour ring relative to a first mold portion to apply a force on the edge portion at the first major surface of the first ply substrate.

Embodiment 3 provides the method of Embodiment 2, optionally wherein the mold further comprises a second mold portion configured as a bending ring to engage the edge portion at the second major surface of the second ply substrate.

Embodiment 4 provides the method of any one or combination of Embodiments 1-3, optionally further comprising subsequent to pressing, applying a vacuum to at least one of the edge portion, the first major surface and the second major surface.

Embodiment 5 provides the method of any one or combination of Embodiments 1-4, optionally wherein the first composition of the first ply substrate comprises soda lime silicate glass, alkali aluminosilicate glass, alkali containing borosilicate glass, alkali aluminophosphosilicate glass, alkali aluminoborosilicate glass, or a mixture thereof, and wherein the first thickness of the first ply substrate is in a range from about 1.5 mm to about 5 mm.

Embodiment 6 provides the method of any one or any combination of Embodiments 1-5, optionally wherein the second ply substrate comprises one of a chemically strengthened glass or glass-ceramic material, and wherein the second thickness is in a range of from about 0.1 mm to about 1.7 mm.

Embodiment 7 provides the method of any one or any combination of the Embodiments 1-6, optionally wherein engaging the edge portion forms a seal at the edge portion to seal a region between the first ply substrate and the second ply substrate.

Embodiment 8 provides the method of any one or any combination of Embodiments 1-7, optionally further comprising providing a compressed gas to at least one of the first major surface and the second major surface of the glass laminate structure.

Embodiment 9 provides a method of bending a glass laminate structure, the method can optionally comprise any one or any combination of: heating the glass laminate structure comprising only a first ply substrate and a second ply substrate, wherein the first ply substrate has a first composition and a first thickness that differ from a second composition and a second thickness of the second ply substrate; engaging a first major surface with a press mold to bend the glass laminate structure and obtain a desired curvature of the glass laminate structure along one or both of a first major surface and a second major surface; and pressure forming the glass laminate structure against the press mold with a compressed gas applied to the second major surface of the glass laminate structure.

Embodiment 10 provides the method of Embodiment 9, optionally further comprising: prior to engaging the first major surface with the press mold, pressing the glass laminate structure with a contour ring at an edge portion of one of the first major surface or the second major surface; wherein engaging the first major surface with the press mold comprises engaging a portion of the first major surface other than the edge portion of the glass laminate structure with the press mold.

Embodiment 11 provides the method of any one or combination of Embodiments 9-10, optionally further comprising vacuum forming the glass laminate structure after engaging the first major surface with the press mold.

Embodiment 12 provides a system for bending a glass laminate structure, the system can optionally comprise any one or any combination of: a contour ring configured to extend along an x-direction and a y-direction of the glass laminate structure and configured to engage an edge portion of a first major surface of the glass laminate structure; a support ring extending along the x-direction and the y-direction of the glass laminate structure and comprising a support for the glass laminate structure along an edge portion of a second major surface of the glass laminate structure opposing the edge portion of the first major surface; and a press mold configured to engage a portion of one of the first major surface or the second major surface other than the edge portion; wherein the contour ring is configured to be moveable relative to the press mold to selectively engage the edge portion of the first major surface of the glass laminate structure independent of the press mold.

Embodiment 13 provides the system of Embodiment 12, optionally further comprising a gas supply conduit configured to provide a compressed gas to the second major surface inward of the support ring.

Embodiment 14 provides the system of any one or any combination of Embodiments 12-13, optionally wherein one or both of the press mold and the contour ring have a plurality of vacuum ports therein.

Embodiment 15 provides the system of any one or any combination of Embodiments 12-14, optionally wherein the contour ring further comprises guide rods received in the press mold.

Embodiment 16 provides the system of any one or any combination of Embodiments 12-15 optionally wherein the contour ring is weighted with a mass and the contour ring with the mass is configured to engage the glass laminate structure with a desired force at the edge portion.

Embodiment 17 provides the system of any one or any combination of Embodiments 12-16, optionally wherein the contour ring comprises a hollow frame configured to engage the glass laminate structure with a force at the edge portion.

Embodiment 18 provides the system of any one or any combination of Embodiments 12-17, wherein the press mold comprises a recess configured to receive the contour ring.

Embodiment 19 provides an apparatus comprising glass laminate structure that is a windshield for a vehicle. The glass laminate structure can optionally comprise: a first curved glass substrate comprising a soda lime silicate glass, alkali aluminosilicate glass, alkali containing borosilicate glass, alkali aluminophosphosilicate glass, alkali aluminoborosilicate glass, or a mixture thereof, and wherein the first glass substrate has a first thickness in a range from about 1.5 mm to about 10 mm; and a second curved glass substrate comprising one of a chemically strengthened glass or glass-ceramic material, wherein the second glass substrate has a second thickness is in a range of from about 0.1 mm to about 1.7 mm.

Embodiment 20 provides the glass laminate substrate of Embodiment 19, optionally wherein the first and second glass substrates are formed by a method for bending the glass laminate structure that includes at least one of engaging an edge portion of a first major surface of the glass laminate structure with a contour ring prior to press molding or pressure forming the glass laminate structure against the press mold with a compressed gas applied to the second major surface of the glass laminate structure.

1. A method of bending a glass laminate structure, the method comprising:
heating the glass laminate structure comprising at least a first ply substrate and a second ply substrate, wherein the first ply substrate has a first composition and a first thickness that differ from a second composition and a second thickness of the second ply substrate;
engaging an edge portion of one or both of a first major surface and a second major surface of the glass laminate structure; and
subsequent to engaging the edge portion, pressing the glass laminate structure to bend the glass laminate structure and obtain a desired curvature of the glass laminate structure along one or both of the first major surface and the second major surface.

2. The method of claim 1, wherein engaging the edge portion comprises moving a contour ring relative to a first mold portion to apply a force on the edge portion at the first major surface of the first ply substrate.

3. The method of claim 2, wherein the mold further comprises a second mold portion configured as a bending ring to engage the edge portion at the second major surface of the second ply substrate.

4. The method of claim 1, further comprising subsequent to pressing, applying a vacuum to at least one of the edge portion, the first major surface and the second major surface.

5. The method of claim 1, wherein the first composition of the first ply substrate comprises soda lime silicate glass, alkali aluminosilicate glass, alkali containing borosilicate glass, alkali aluminophosphosilicate glass, alkali aluminoborosilicate glass, or a mixture thereof, and wherein the first thickness of the first ply substrate is in a range from about 1.5 mm to about 5 mm.

6. The method of claim 1, wherein the second ply substrate comprises one of a chemically strengthened glass or glass-ceramic material, and wherein the second thickness is in a range of from about 0.1 mm to about 1.7 mm.

7. The method of claim 1, wherein engaging the edge portion forms a seal at the edge portion to seal a region between the first ply substrate and the second ply substrate.

8. The method of claim 1, further comprising providing a compressed gas to at least one of the first major surface and the second major surface of the glass laminate structure.

9. A method of bending a glass laminate structure, the method comprising:
heating the glass laminate structure comprising only a first ply substrate and a second ply substrate, wherein the first ply substrate has a first composition and a first thickness that differ from a second composition and a second thickness of the second ply substrate;
engaging a first major surface with a press mold to bend the glass laminate structure and obtain a desired curvature of the glass laminate structure along one or both of a first major surface and a second major surface; and
pressure forming the glass laminate structure against the press mold with a compressed gas applied to the second major surface of the glass laminate structure.

10. The method of claim 9, further comprising:
prior to engaging the first major surface with the press mold, pressing the glass laminate structure with a contour ring at an edge portion of one of the first major surface or the second major surface,
wherein engaging the first major surface with the press mold comprises engaging a portion of the first major surface other than the edge portion of the glass laminate structure with the press mold.

11. The method of claim 9, further comprising vacuum forming the glass laminate structure after engaging the first major surface with the press mold.

12. A system for bending a glass laminate structure, the system comprising:
a contour ring configured to extend along an x-direction and a y-direction of the glass laminate structure and configured to engage an edge portion of a first major surface of the glass laminate structure;
a support ring extending along the x-direction and the y-direction of the glass laminate structure and comprising a support for the glass laminate structure along an edge portion of a second major surface of the glass laminate structure opposing the edge portion of the first major surface; and
a press mold configured to engage a portion of one of the first major surface or the second major surface other than the edge portion;
wherein the contour ring is configured to be moveable relative to the press mold to selectively engage the edge portion of the first major surface of the glass laminate structure independent of the press mold.

13. The system of claim 12, further comprising a gas supply conduit configured to provide a compressed gas to the second major surface inward of the support ring.

14. The system of claim 12, wherein one or both of the press mold and the contour ring have a plurality of vacuum ports therein.

15. The system of claim 12, wherein the contour ring further comprises guide rods received in the press mold.

16. The system of claim 12, wherein the contour ring is weighted with a mass and the contour ring with the mass is configured to engage the glass laminate structure with a desired force at the edge portion.

17. The system of claim 12, wherein the contour ring comprises a hollow frame configured to engage the glass laminate structure with a force at the edge portion.

18. The system of claim 12, wherein the press mold comprises a recess configured to receive the contour ring.

19. (canceled)

20. (canceled)
